(19) United States
(12) Patent Application Publication
(10) Pub. No.: US 2003/0206019 A1
(43) Pub. Date: Nov. 6, 2003

(54) Wireless RF module for an MR imaging system

(76) Inventor: Eddy B. Boskamp, Menomonee Falls, WI (US)

Correspondence Address: ZIOLKOWSKI PATENT SOLUTIONS GROUP, LLC (GEMS), 14135 NORTH CEDARBURG ROAD, MEQUON, WI, 53097, US

(21) Appl. No.: 10/063,550

(22) Filed: May 2, 2002

(51) Int. Cl. G01V 3/00

(52) U.S. Cl. 324/322; 324/318

(57) ABSTRACT

The present invention provides a system and method wirelessly transmitting MR signals from receive coils of an RF coil assembly to a remotely located receiver system. By utilizing wireless telemetry, ghosting, SNR problems, and standing waves on shields typically associated with cabled receive coils are avoided. Furthermore, by incorporating a rechargeable battery in place of DC cables, the coaxial cable conducting large currents can be eliminated. The present invention incorporates a transmitter that transmits a modulated MR signal to a receiver at the end of the bore of the magnet of the MRI system. Modulating the MR signals with a carrier frequency enables wireless transmission of the modulated signal to the remote receiver. Preferably, the modulated signal is transmitted using a 900 MHz carrier frequency. The receiver then demodulates the received signal and transmits the resulting signal to a system control for subsequent processing and image reconstruction.

### BACKGROUND OF INVENTION

The present invention relates generally to magnetic resonance imaging (MRI) and, more particularly, to a wireless RF module for wirelessly transmitting acquired MR signals from a receive coil of an MRI system.

When a substance such as human tissue is subjected to a uniform magnetic field (polarizing field B₀), the individual magnetic moments of the spins in the tissue attempt to align with this polarizing field, but precess about it in random order at their characteristic Larmor frequency. If the substance, or tissue, is subjected to an RF magnetic field (excitation field B₁) which is in the x-y plane and which is near the Larmor frequency, the net aligned moment, or “longitudinal magnetization”, M_{Z}, may be rotated, or “tipped”, into the x-y plane to produce a net transverse magnetic moment Mₜ. A signal is emitted by the excited spins after the excitation signal B₁ is terminated and this signal may be received and processed to form an image.

When utilizing these signals to produce images, magnetic field gradients (GₓG_{y} and G_{z}) are employed. Typically, the region to be imaged is scanned by a sequence of measurement cycles in which these gradients vary according to the particular localization method being used. The resulting set of received signals are digitized and processed to reconstruct the image using one of many well known reconstruction techniques.

Generally, the RF coil assembly of an MRI system includes a transmit coil to create the B₁ field and a receive coil used in conjunction with the transmit coil to detect or receive the signals from the excited spins in the imaged object. Typically, each receive coil of the RF coil assembly is connected to the receive chain of the MRI system via a coaxial transmission line or cable. Because of the proximity of coaxial cables for the receive coils with respect to one another, ghosting and signal-to-noise (SNR) related problems can occur and to prevent standing waves on the cable shields during the transmit pulse.

Additionally, the receive coils of the RF coil assembly are typically supplied power through a series of DC cables. During the transmit pulse with the transmit coil, large voltages and currents can be induced in the DC cables and the shields of the coaxial cables.

It would therefore be desirable to have a system and method capable of wirelessly transmitting an MR signal from the receive coil of an RF coil assembly to a remote receiver module as well as a system absent of the DC cables typically connected to the receive coil which can further increase overall safety of the device.

### BRIEF SUMMARY OF INVENTION

The present invention provides a system and method overcoming the aforementioned problems by providing wireless transmission of MR signals from receive coils of an RF coil assembly to a remotely located receiver system. By utilizing wireless telemetry, ghosting and SNR problems typically associated with cabled receive coils are avoided. Furthermore, by incorporating a rechargeable battery in place of DC cables, concerns regarding contact with a coaxial cable conducting large currents are negated. The present invention incorporates a transmitter that transmits a modulated MR signal to a receiver remote from the imaging bay of the MRI system. Modulating the MR signals with a carrier frequency enables wireless transmission of the modulated signal to the remote receiver. Preferably, the modulated signal is transmitted using a 900 MHz carrier frequency. The receiver then demodulates the received signal and transmits the resultant signal to a system control for subsequent processing and image reconstruction.

In accordance with one aspect of the present invention, a wireless RF module for an MRI apparatus is provided. The module includes a modulator configured to modulate a carrier signal with an MR signal in an RF coil of the MRI apparatus. A transmitter is provided and configured to transmit the modulated MR signal. A receiver is wirelessly connected to the transmitter and configured to receive the modulated MR signal for subsequent data processing and image reconstruction.

In accordance with another aspect of the present invention, an MRI apparatus comprises an MRI system having a number of gradient coils positioned about a bore of a magnet to impress a polarizing magnetic field. The MRI apparatus further includes an RF transceiver system and an RF coil assembly configured to wirelessly transmit an MR signal to the RF transceiver system.

In accordance with a further aspect of the present invention, an MRI system comprises means for positioning a subject to be scanned within a bore of magnet assembly for MR data acquisition. The MRI system further includes means for impressing a polarizing magnetic field about the bore of the magnet and means for exciting nuclei in the subject. The MRI system further comprises means for sensing signals resulting from the excited nuclei in the subject and means for wirelessly transmitting the signals to a receiver means. Means for reconstructing at least one image of the subject from the signals received by the receiver means is also provided.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention.

In the drawings:

FIG. 1 is a schematic block diagram of an MRI system incorporating the present invention.

FIG. 2 is a schematic block diagram of a wireless RF module for use with an MRI system.

### DETAILED DESCRIPTION

The present invention will be described with respect to a whole body RF coil assembly of an MRI system having a transmit coil to create a B₁ field and a receive coil used in conjunction with the transmit coil to detect or receive the signals from excited spins of nuclei in an imaged object.

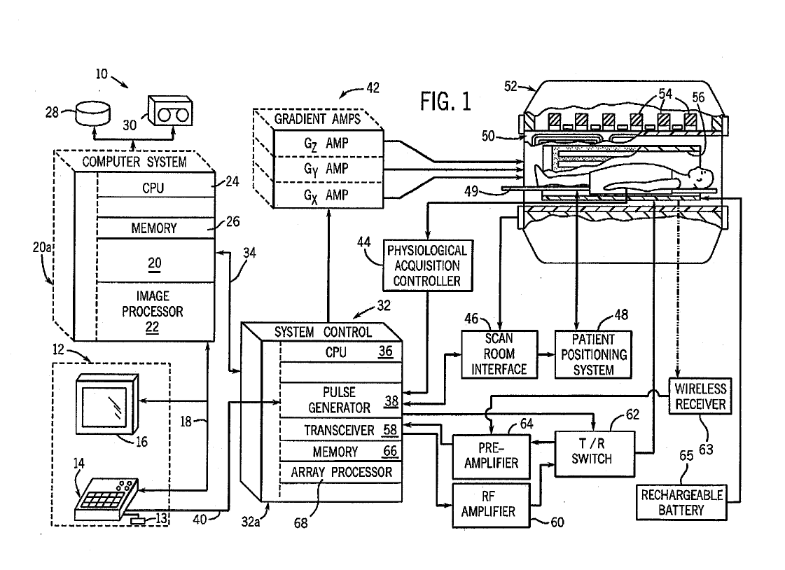

Referring to FIG. 1, the major components of a preferred magnetic resonance imaging (MRI) system 10 incorporating the present invention are shown. The operation of the system is controlled from an operator console 12 which includes a keyboard or other input device 13, a control panel 14, and a display screen 16. The console 12 communicates through a link 18 with a separate computer system 20 that enables an operator to control the production and display of images on the display screen 16. The computer system 20 includes a number of modules which communicate with each other through a backplane 20a. These include an image processor module 22, a CPU module 24 and a memory module 26, known in the art as a frame buffer for storing image data arrays. The computer system 20 is linked to disk storage 28 and tape drive 30 for storage of image data and programs, and communicates with a separate system control 32 through a high speed serial link 34. The input device 13 can include a mouse, joystick, keyboard, track ball, touch activated screen, light wand, voice control, or any similar or equivalent input device, and may be used for interactive geometry prescription.

The system control 32 includes a set of modules connected together by a backplane 32a. These include a CPU module 36 and a pulse generator module 38 which connects to the operator console 12 through a serial link 40. It is through link 40 that the system control 32 receives commands from the operator to indicate the scan sequence that is to be performed. The pulse generator module 38 operates the system components to carry out the desired scan sequence and produces data which indicates the timing, strength and shape of the RF pulses produced, and the timing and length of the data acquisition window. The pulse generator module 38 connects to a set of gradient amplifiers 42, to indicate the timing and shape of the gradient pulses that are produced during the scan. The pulse generator module 38 can also receive patient data from a physiological acquisition controller 44 that receives signals from a number of different sensors connected to the patient, such as ECG signals from electrodes attached to the patient. And finally, the pulse generator module 38 connects to a scan room interface circuit 46 which receives signals from various sensors associated with the condition of the patient and the magnet system. It is also through the scan room interface circuit 46 that a patient positioning system 48 receives commands to move the patient to the desired position for the scan.

The gradient waveforms produced by the pulse generator module 38 are applied to the gradient amplifier system 42 having Gₓ, G_{y}, and G_{z} amplifiers. Each gradient amplifier excites a corresponding physical gradient coil in a gradient coil assembly generally designated 50 to produce the magnetic field gradients used for spatially encoding acquired signals. The gradient coil assembly 50 forms part of a magnet assembly 52 which includes a polarizing magnet 54 and a whole-body RF coil assembly 56. Preferably, assembly 56 includes a transmit coil (not shown) to create a B₁ field and a receive coil (not shown) used in conjunction with the transmit coil to detect or receive the signals from excited spins of nuclei in the imaged object.

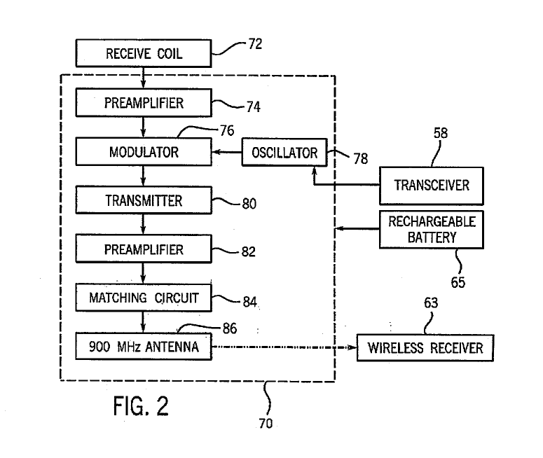

A transceiver module 58 in the system control 32 produces pulses which are amplified by an RF amplifier 60 and coupled to the transmit coil of RF coil assembly 56 by a transmit/receive switch 62. The resulting signals emitted by the excited nuclei in the patient are sensed by the receive coil of RF coil assembly 56 and wirelessly transmitted to a receiver 63. The received signals are then input to a preamplifier 64. The amplified MR signals are demodulated, filtered, and digitized in the receiver section of the transceiver 58. The transmit/receive switch 62 is controlled by a signal from the pulse generator module 38 to electrically connect the RF amplifier 60 to the coil assembly 56 during the transmit mode and activate a transmitter (not shown) to wirelessly transmit the MR signals to receiver 63 during the receive mode, as will be described with respect to FIG. 2. The transmit/receive switch 62 can also enable a separate RF coil (for example, a surface coil) to be used in either the transmit or receive mode. As will be described in greater detail below, the transmitter includes a number of components to facilitate wireless transmission of MR signals to receiver 63. A rechargeable battery 65 is also provided to provide cableless power to the transmitter and its respective components.

The MR signals picked up by the receive coil of RF coil assembly 56 and transmitted to receiver 63 are digitized by the transceiver module 58 and transferred to a memory module 66 in the system control 32. A scan is complete when an array of raw k-space data has been acquired in the memory module 66. This raw k-space data is rearranged into separate k-space data arrays for each image to be reconstructed, and each of these is input to an array processor 68 which operates to Fourier transform the data into an array of image data. This image data is conveyed through the serial link 34 to the computer system 20 where it is stored in memory, such as disk storage 28. In response to commands received from the operator console 12, this image data may be archived in long term storage, such as on the tape drive 30, or it may be further processed by the image processor 22 and conveyed to the operator console 12 and presented on the display 16.

Referring now to FIG. 2, an RF module 70 for wirelessly transmitting MR signals detected of an imaged object to a receiver 63 for subsequent processing is schematically illustrated. Module 70 picks up the signals from a receive coil 72 and transmits the signal to a wireless receiver 63. A rechargeable battery 65 is also provided and preferably located in the receive coil 72 to provide power to module 70 and its components. The battery 65 may be a charged battery and charged at a remote location thereby eliminating the need for charging the battery while in the system. This also avoids any down time to the system resulting from charging the battery. Notwithstanding the above, a non-rechargeable battery may also be used. Preferably, the transmit pulse from the transmit coil may be picked up, rectified by a rectifier (not shown), and straightened by a capacitor (not shown) to provide the requisite power to module 70 and to keep the battery charged in accordance with well known rectifying techniques.

To achieve wireless transmission of signals from the bore of the magnet of the MRI system, FIG. 1, module 70 includes a preamplifier 74 proximate the receive coil 72 and configured to receive the MR signal therefrom. Preferably, preamplifier 74 is located on a surface of the receive coil 72. The preamplifier 74 inputs the MR signal to a modulator 76, such as a diode circuit, wherein the MR signal is modulated with a carrier signal from a local oscillator 78 that may be located on the receive coil as well. Modulator 76 amplitude modulates the MR signal with the carrier signal from oscillator 78. Preferably, the carrier signal has a frequency approximate to the 900 MHz frequency range.

The modulated MR signal is then fed from modulator 76 to a transmitter 80, preferably a 900 MHz transmitter. In anticipation of reduced or inadequate signal strength for wireless transmission, module 70 includes a second preamplifier 82 that amplifies the signal from transmitter 80. In this embodiment, a matching circuit 84 is also provided which transmits the amplified modulated signal to a 900 MHz antenna 86. If the strength of the MR signal is sufficient for wireless transmissions, module 70 may be configured absent preamplifier 82. Typically, the MR signal need only travel a few meters, therefore, a module 70 absent component 82 is likely, but a module incorporating component 82 to provide additional signal strength for wireless transmission across several meters is contemplated.

The antenna 86 then transmits the modulated signal to a receiver 63 located preferably at the end of the bore of the magnet and configured to receive the signal and subsequently feed the signal to a data processor via a preamplifier 64 and transceiver 58, FIG. 1, for subsequent processing and image reconstruction. Alternately, receiver 63 may be incorporated with transceiver 58 of FIG. 1 by implementing an antenna stub on the transceiver. Further, receiver 63 includes demodulation circuitry to demodulate the received signal. The receiver, however, may feed the received signal to a demodulator (not shown) for signal demodulation.

It is noted that FIG. 2 shows oscillator 78 connected to transceiver 58. This connection is to show the need to have phase coherence between the two local oscillators. The phase coherency can be performed by determining the phase of the RF pulse.

Additionally, the present invention is applicable with known imaging protocols and techniques. Further, the present invention may be utilized as a kit to retrofit existing cabled MRI systems to thereby take advantage of the benefits heretofore described.

In one embodiment of the present invention, a wireless RF module for an MRI apparatus is provided. The module includes a modulator configured to modulate a carrier signal with an MR signal in an RF coil of the MRI apparatus. A transmitter is provided and configured to transmit the modulated MR signal. A receiver is wirelessly connected to the transmitter and configured to receive the modulated MR signal for subsequent data processing and image reconstruction.

In another embodiment of the present invention, an MRI apparatus comprises an MRI system having a number of gradient coils positioned about a bore of a magnet to impress a polarizing magnetic field. The MRI apparatus further includes an RF transceiver system and an RF coil assembly configured to wirelessly transmit an MR signal to the RF transceiver system.

In a further embodiment of the present invention, an MRI system comprises means for positioning a subject to be scanned within a bore of magnet assembly for MR data acquisition. The MRI system further includes means for impressing a polarizing magnetic field about the bore of the magnet and means for exciting nuclei in the subject. The MRI system further comprises means for sensing signals resulting from the excited nuclei in the subject and means for wireless transmitting the signals to a receiver means. Means for reconstructing at least one image of the subject from the signals received by the receiver means is also provided.

The present invention has been described in terms of the preferred embodiment, and it is recognized that equivalents, alternatives, and modifications, aside from those expressly stated, are possible and within the scope of the appending claims.

What is claimed is:

1. A wireless RF module for an MRI apparatus, the wireless RF coil module comprising:
a modulator configured to modulate a carrier signal with an MR signal in an RF coil of the MRI apparatus;
a transmitter configured to transmit the modulated signal; and
a receiver wirelessly connected to the transmitter and configured to receive the modulated signal for subsequent data processing and image reconstruction.

2. The module of claim 1 wherein the modulator is further configured to amplitude modulate the carrier signal.

3. The module of claim 1 wherein the carrier signal has a frequency between approximately 300 MH_{Z} to approximately 3 GH_{Z}.

4. The module of claim 1 wherein the receiver is located remotely from the MRI apparatus.

5. The module of claim 1 wherein the receiver includes an electric dipole antenna.

6. The module of claim 1 wherein the transmitter is further configured to transmit the modulated signal out of a bore defined by a magnet assembly of the MRI apparatus.

7. The module of claim 1 incorporated into a kit and configured to retrofit an existing MRI apparatus to wirelessly transmit the MR signal from a receive coil of the MRI apparatus to a receiver configured input the received MR signal to a data processor for processing and image reconstruction.

8. An MRI apparatus comprising:
an MRI system having a number of gradient coils positioned about a bore of a magnet to impress a polarizing magnetic field;
an RF transceiver system; and
an RF coil assembly configured to wirelessly transmit an MR signal to the RF transceiver system.

9. The MRI apparatus of claim 8 wherein the RF coil assembly includes an RF modulator configured to modulate a UHF carrier frequency with the MR signal.

10. The MRI apparatus of claim 9 wherein the RF modulator is further configured to amplitude modulate the UHF carrier frequency with the MR signal.

11. The MRI apparatus of claim 8 wherein the RF coil assembly further comprises a transmitter configured to wirelessly transmit the MR signal out of the bore of the magnet.

12. The MRI apparatus of claim 11 wherein the RF coil assembly further comprises a receiver wirelessly connected to the transmitter and configured to receive the modulated signal transmitted by the transmitter.

13. The MRI apparatus of claim 12 further comprising an electric dipole antenna attached to the receiver.

14. The MRI apparatus of claim 12 wherein the receiver is positioned at an end of the bore from the MRI system.

15. The MRI apparatus of claim 11 further comprising a rechargeable battery configured to provide power to the RF modulator and the transmitter.

16. The MRI apparatus of claim 8 wherein the RF coil assembly further comprises a pre-amplifier, a local oscillator, and a 900 MH_{Z} transmitter.

17. An MRI system comprising:
means for positioning a subject to be scanned within a bore of a magnet assembly for MR data acquisition;
means for impressing a polarizing magnetic about the bore of the magnet;
means for exciting nuclei in the subject;
means for sensing signals resulting from the exciting nuclei in the subject;
means for wirelessly transmitting the signals to a receiver means; and
means for reconstructing at least one image of the subject from the signals received by the receiver means.

18. The MRI system of claim 17 wherein the receiver means includes means for wirelessly receiving the signals transmitted by the means for wirelessly transmitting.

19. The MRI system of claim 17 further comprising means for acquiring power for components of the MRI system from a B field associated with an RF transmit pulse sequence from the means for exciting nuclei in the subject.

20. The MRI system of claim 19 further comprising means for rectifying induced voltage generated during excitation of nuclei in the subject.

21. The MRI system of claim 20 further comprising at least one battery and means for charging the at least one battery from the induced voltage.

22. The MRI system of claim 17 further comprising means for improving SNR.
